(19) United States
(12) Patent Application Publication
(10) Pub. No.: US 2025/0324468 A1
(43) Pub. Date: Oct. 16, 2025

(54) DYNAMIC ANYCAST SERVICE-SUPPORTED PACKET DATA UNIT SESSION ESTABLISHMENT METHOD AND APPARATUS FOR MOBILE NETWORKS

(71) Applicant: FOUNDATION OF SOONGSIL UNIVERSITY-INDUSTRY COOPERATION, Seoul (KR)

(72) Inventor: Young Han KIM, Seoul (KR)

(21) Appl. No.: 19/092,436

(22) Filed: Mar. 27, 2025

(30) Foreign Application Priority Data
Apr. 11, 2024 (KR) 10-2024-0048615
Jun. 5, 2024 (KR) 10-2024-0073442

(51) Int. Cl. H04W 76/12; H04L 45/00; H04L 45/02; H04L 47/70

(52) U.S. Cl. CPC H04W 76/12; H04L 45/02; H04L 45/34; H04L 47/825

(57) ABSTRACT

A dynamic anycast service-supported packet data unit (PDU) session establishment method includes: (a) transmitting/receiving a session management context (CreateSMContext) request/response with an Access Management Function (AMF) by means of a Session Management Function (SMF) when there is a PDU session establishment request for an anycast service of UE; (b) performing a PDU session establishment procedure for logical connection between the UE and a data network without selecting a User Plane Function (UPF) for packet transmission and reception by means of the SMF; and (c) sending session information including Core Network (CN) Tunnel Info to a Computing-Aware Traffic Steering-Mobile User Plane-Controller (CATS-MUP-C) through a Nsmf_EventExposure service by means of the SMF, wherein the CATS-MUP-C sets up uplink by a segment routing underlay network by converting the session information into routing information of a UE-RAN and the data network.

### CROSS-REFERENCE TO RELATED APPLICATION

This application claims the benefit of priority under 35 U.S.C. § 119 (a) to Korean Patent Application No. 10-2024-0048615 filed on Apr. 11, 2024 and Korean Patent Application No. 10-2024-0073442 filed on Jun. 5, 2024, the entire contents of which are incorporated herein by reference.

### BACKGROUND

### (a) Technical Field

The present disclosure relates to a dynamic anycast service-supported Packet Data Unit (PDU) session establishment method and apparatus for mobile networks.

### (b) Background Art

In the SRv6 (Segment Routing over IPv6) architecture, a Mobile User Plane (MUP) is used to enable an SR data plane to integrate the mobile user plane over an IP network.

IPv6 with a large address space, which can be used for SR, is suitable for IP connection requirements of mobile services to handle a large number of nodes in millions of base stations.

An MUP using SRv6 can replace IP connections for both interface N3 (the interface between gNB and UPF) and N6 (the interface between UPF and a data network).

An MUP architecture mainly consists of a controller node for an SR network (MUP-C) and an MUP aware Provider Edge node (MUP-PE).

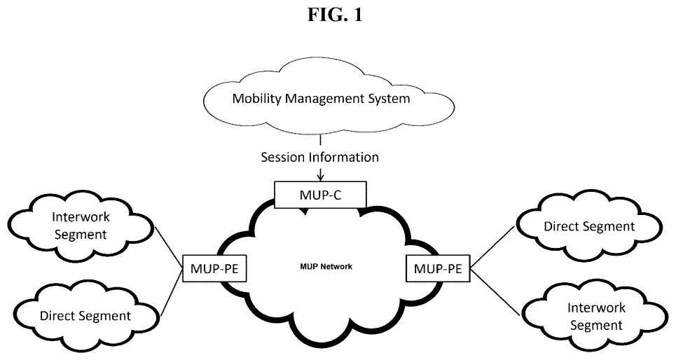

FIG. 1 is a diagram showing a mobile user plane architecture.

Referring to FIG. 1, an MUP-C converts received session information into routing information and then advertises the session-transformed route to an SR domain.

An approach method is that the traffic sent by a user can be routed directly to a service instance through an SR underlay network.

The MUP architecture has three main principles.

The first one is the abstraction of MUP. An MUP segment is used to represent a network segment including mobile services. The MUP-PE can accommodate an MUP segment such as interwork segment (which provides connection between a user plane protocol of a mobile service architecture and another MUP segment via an MUP network) and/or a direct segment (which provides connection between MUP segments via an MUP network).

The second one is auto-discovery for MUP segments. The auto-discovery is a function that automatically identifies and registers new devices when they are discovered in or added to a network.

An MUP-PE must be able to discover MUP segments from a remote MUP-PE, and the remote MUP-PE must advertise an auto-discovery route for a hosted MUP segment. The MUP-PE can discover the MUP segment of the remote MUP-PE only when it can find MUP segment information in the received auto-discovery route.

The last principle is the role of an MUP-C that converts session information into routing information.

Hereafter, a Computing-Aware Traffic Steering (CATS) framework is described.

A CATS framework is used to select an appropriate service instance from a set of available service contact instances through networking and computing metrics in a selection process.

The idea of CATS is that the resources of a service site hosting service instances are limited and the availability of the resources fluctuates over time.

Accordingly, considering networking and computing resource metrics, it can generally help to provide service instances suitable for traffic rather than depending on the geographical locations of instances.

The CATS framework includes essential functional components such as CATS forwarder, CATS Path Selector (C-PS), CATS Service Metric Agent (C-SMA), CATS Network Metric Agent (C-NMA), and CATS Traffic Classifier (C-TC).

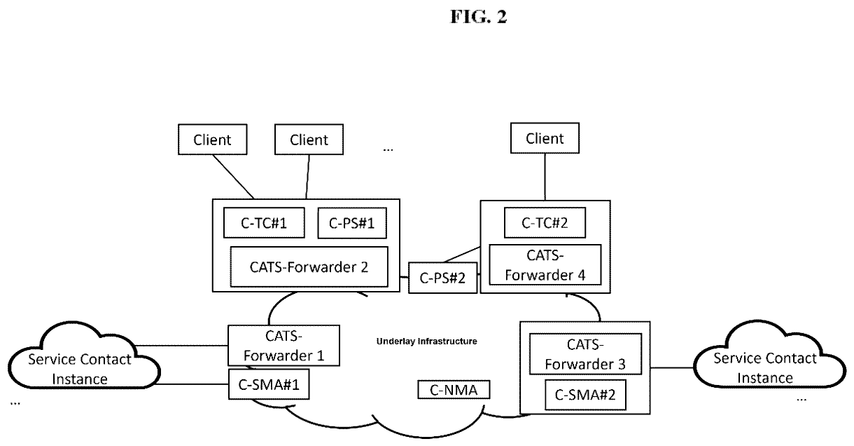

FIG. 2 is a diagram showing the relationship between CATS functional components.

Referring to FIG. 2, a C-NMA and a C-SMA are each responsible for collecting networking and computing resource metrics.

C-TC is for determining the packets belonging to the traffic flow for a specific service request and forwarding the packets along a C-PS computed path.

C-PS calculates and selects a service request path using service and network status information.

CATS-forwarder makes a forwarding decision for service instances in consideration of CATS information. This consists of an ingress CATS forwarder that steers traffic to an egress CATS forwarder along a selected CATS computed path. The egress CATS is connected to a CATS service site.

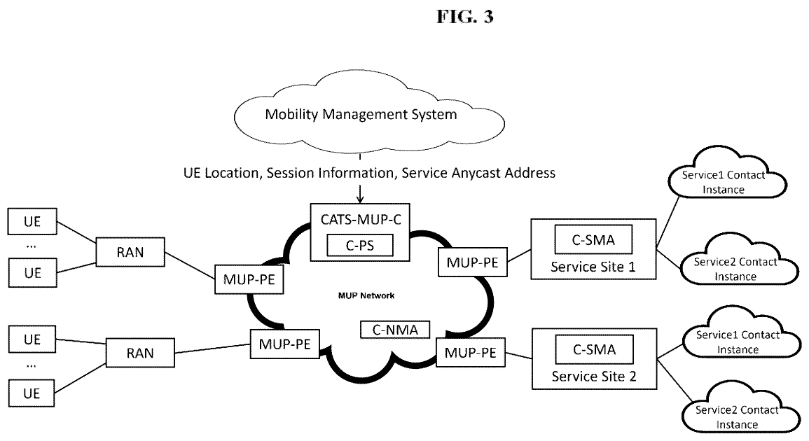

FIG. 3 is a diagram showing a CATS-MUP-C architecture.

The CATS-MUP-C architecture proposes CATS-MUP-C that integrates C-PS and MUP-C functions to improve a distributed mobile user plane architecture.

The CATS-MUP-C determines an optimal service instance on the basis of session information collected from an application server and an underlay network, and CATS metrics.

In this decision-making process performed by the C-PS, which is a lower component, the location of User Equipment (UE) is also considered. The architecture separates the CATS-based service instance location selection from an upper control plane and integrates it into the MUP-C. As a result, for the same anycast service request, it is possible to dynamically route various users to service instances at various locations on the basis of CATS information and UE location.

An anycast service request may be a service request based on an anycast IP or a data Network Name (DNN).

In an SRv6-MUP architecture, an MUP-C is a functional entity responsible for converting corresponding session information into routing information called an ST route (Session-Transformed Route) in an SR underlay network.

Received session information includes UE or a Mobile Node (MN) IP prefix, tunnel endpoint identifiers for both ends, and other attributes for a mobile network.

Thereafter, the MUP-C advertises the ST route for the UE or MN to the MUP-PE. The route types include a segment discovery route (i.e., a Direct Segment Discovery (DSD) route and an interwork segment discovery route) and a session-transformed route (type 1) session-transformed route and type 2 session-transformed route).

The DSD route is very important for an MUP-PE when interfacing with a network. An MUP-PE notifies an SR domain of a corresponding DSD route when connecting to a network via an interface or a routing instance. This route includes the MUP-PE address of Network Layer Reachability Information (NLRI) along with an extended community representing a connected direct segment.

Further, attributes per data plane are connected to ensure automatic discovery as specified in the architecture. For example, in the context of 3GPP 5G using an SRv6 data plane, the DSD route of a Data Network (DN) includes the MUP-PE address of NLRI, an SRv6 Specific Identifier (SID), and a direct segment extended community. When receiving a DSD route from another MUP-PE, the MUP-PE maintains it in a Routing Information Base (RIB). This route helps to check the connectivity to the type 2 session-transformed route. When the DSD route successfully verifies the connectivity to an endpoint and matches the direct segment extended community of the type 2 session-transformed route, the MUP-PE updates the Forwarding Information Base (FIB) entry for the type 2 session-transformed route using the SID of the matching DSD route.

The type 2 session-transformed route encodes the tunnel endpoint identifier of a core-side session using Border Gateway Protocol Multiprotocol (BGP MP)-NLRI. This route type uses the longest match algorithm for prefix aggregation to improve scalability. The MUP-C propagates these routes in an MUP network using a route target and direct segment extension communities for endpoint designation.

In an SR domain, the MUP-PE receives and maintains these routes and can acquire routing instances configured on the basis of the route target extended community. Routes that do not match these communities are discarded to ensure network consistency and scalability.

An Interwork Segment Discovery (ISD) route is essential for the network of a mobile service architecture to interface with an MUP-PE.

When an MUP-PE is connected to a network through an interface or routing instance to an interwork segment, it advertises a corresponding ISD route containing the prefix of the interwork segment. This route includes data plane-specific attributes for auto-discovery, so it ensures compatibility among various architectures.

For example, in 3GPP 5G using an SRv6 data plane, the ISD route of an N3RAN network includes the RAN (Radio Access Network) IP prefix in NLRI and a corresponding SRv6 SID. When the ISD route is received, the MUP-PE stores it in an RIB and uses it to check the connectivity to the remote endpoint of the type 1 session-transformed route.

When the ISD route successfully verifies the connectivity of the type 1 session-transformed route, the MUP-PE updates the FIB entry for the corresponding prefix using the SID of the matching ISD route. The important point is that the ISD route should only be used to check the connectivity to the remote endpoint of the type 1 session-transformed route to avoid mixing with other routing instances. Further, the MUP-PE can delete the received ISD route if the route target extension community does not comply with the MUP-PE's import policy.

The type 1 session-transformed route facilitated by the MUP-C encodes the IP prefix and session details for UE or an MN using BGP MP-NLRI. In the MUP network, the MUP-PE receives and imports this route on the basis of the specified route target extended community.

Routes that do not match these communities are discarded to ensure network consistency and efficiency.

As described above, the current CATS-MUP-C architecture focuses only on supporting selection of an optimal independent anycast IP service selection. However, collaboration between a mobile network (e.g., 5G) and a CATS-MUP-C for creating mobile sessions to handle user's requests is currently missing.

### SUMMARY OF THE DISCLOSURE

In order to solve the problems of the related art described above, an object of the present disclosure is to provide a solution for a dynamic anycast IP PDU session establishment procedure for a mobile network supporting a CATS-MUP-C.

In order to achieve the objects, according to an embodiment of the present disclosure, there is provided a dynamic anycast service-supported packet data unit session establishment method for mobile networks, including: (a) transmitting/receiving a session management context (CreateSMContext) request/response with an Access Management Function (AMF) by means of a Session Management Function (SMF) when there is a PDU session establishment request for an anycast service of UE; (b) performing a PDU session establishment procedure for logical connection between the UE and a data network without selecting a User Plane function (UPF) for packet transmission and reception by means of the SMF; and (c) sending session information including Core Network (CN) Tunnel Info to a Computing-Aware Traffic Steering-Mobile User Plane-Controller (CATS-MUP-C) through a Nsmf_EventExposure service by means of the SMF, wherein the CATS-MUP-C sets up uplink by a segment routing underlay network by converting the session information into routing information of a user equipment-radio access network (UE-RAN) and the data network.

In the step (b), the SMF may independently create UPF parameters including an address of a virtual UPF and a core network side tunnel endpoint identifier (TEID) for PDU session establishment.

In the step (b), the SMF may transmit and receive N4 session establishment requests/responses with an anycast UPF that only includes a control plane, without transmitting and receiving packets.

The anycast UPF may include only a Packet Forwarding Control Protocol (UPF-PFCP) component among the UPF-PFCP component and a UPF-EXPOSURE component for event exposure services included in a control service group and may not include a data plane service group for packet transmission and reception with an external network.

The Nsmf_EventExposure service may include IP address/prefix of the UE, PDU session establishment and release-related information, user plane status information, and the session information.

The session information may include the CN Tunnel Info, AN (Access Network) Tunnel Info for connection to the data network, the IP address/prefix of the UE, and anycast IP address/prefix.

The method may further include sending the AN Tunnel Info to the CATS-MUP-C by means of the SMF, wherein the CATS-MUP-C may set up downlink by the segment routing underlay network by converting the AN Tunnel Info into routing information.

The CATS-MUP-C may perform control such that packets are transmitted and received between the UE and Mobile Edge Computing (MEC) selected for the anycast service through one or more MUP aware Provider Edge (MUP-PE) nodes, after the PDU session establishment is completed through setup of the uplink and the downlink.

The CATS-MUP-C may convert the CN Tunnel Info into a Direct Segment Discovery (DSD) route and may advertise a second type session-transformed (ST) route to the MUP-PE.

The CATS-MUP-C may convert the AN Tunnel Info into an Interwork Segment Discovery (ISD) route and may set up a route in the segment routing underlay network using a first type ST route.

According to another aspect of the present disclosure, a dynamic anycast service-supported packet data unit session establishment apparatus for mobile networks includes: a processor; and a memory connected to the processor, wherein the memory stores program instructions that are executed by the processor to transmit/receive a session management context (CreateSMContext) request/response with an Access Management Function (AMF) when there is a PDU session establishment request for an anycast service of UE; to perform a PDU session establishment procedure for logical connection between the UE and a data network without selecting a User Plane Function (UPF) for packet transmission and reception; and to send session information including Core Network (CN) Tunnel Info to a Computing-Aware Traffic Steering-Mobile User Plane-Controller (CATS-MUP-C) through a Nsmf_EventExposure, wherein the CATS-MUP-C may set up uplink by a segment routing underlay network by converting the session information into routing information of a UE-RAN and the data network.

The apparatus may be a Session Management Function (SMF), and the SMF may independently create UPF parameters including an address of a virtual UPF and a core network side tunnel endpoint identifier (TEID) for PDU session establishment.

The SMF may transmit and receive N4 session establishment requests/responses with an anycast UPF that only includes a control plane, without transmitting and receiving packets.

The anycast UPF may include only a Packet Forwarding Control Protocol (UPF-PFCP) component among the UPF-PFCP component and a UPF-EXPOSURE component for event exposure services included in a control service group and may not include a data plane service group for packet transmission and reception with the external network.

The Nsmf_EventExposure service may include IP address/prefix of the UE, PDU session establishment and release-related information, user plane status information, and the session information.

According to still another aspect of the present disclosure, UE for providing an anycast service includes: a wireless transceiver for transmitting and receiving wireless signals; a memory storing program instructions; and a processor executing the program instructions and controlling the transceiver, wherein the processor connects to a mobile network through the wireless transceiver and transmits a PDU session establishment request signal for an anycast-based service to an Access Management Function (AMF); and performs control to perform a PDU session establishment procedure for logical connection with a data network without selection of a User Plane Function (UPF) for packet transmission and reception via the SMF of the mobile network, and send session information including Core Network (CN) Tunnel Info to the Computing-Aware Traffic Steering-Mobile User Plane-Controller (CATS-MUP-C) via a Nsmf_EventExposure service such that packets are transmitted and received with the data network through the transceiver when uplink and downlink by a segment routing underlay network are set up.

According to the present disclosure, there is the advantage that it is possible to establish a dynamic anycast IP PDU session for a mobile network supporting a CATS-MUP-C.

### BRIEF DESCRIPTION OF THE DRA WINGS

FIG. 1 is a diagram showing a mobile user plane architecture.

FIG. 2 is a diagram showing the relationship between CATS functional components.

FIG. 3 is a diagram showing a CATS-MUP-C architecture.

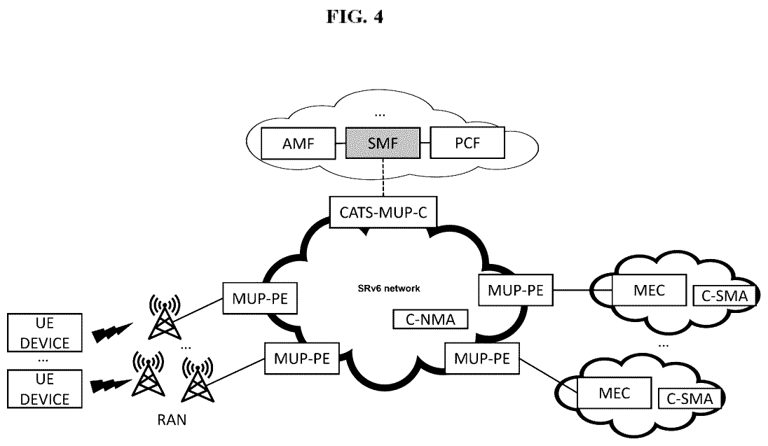

FIG. 4 is a diagram showing a system in which an SMF according to the present embodiment independently performs a PDU session establishment procedure.

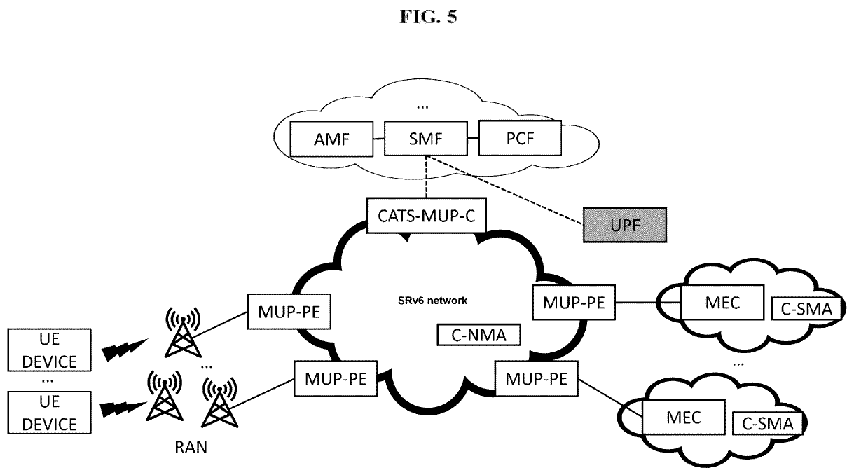

FIG. 5 is a diagram showing a system in which the SMF according to the present embodiment performs a PDU session establishment procedure by communicating with an anycast UPF.

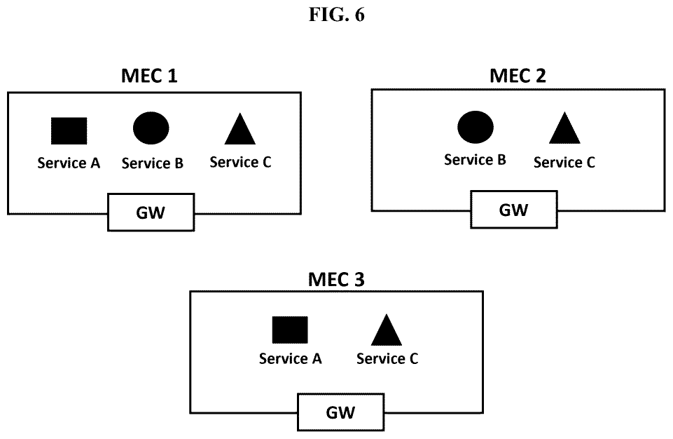

FIG. 6 is a diagram showing an anycast service that is executed at an MEC site according to the present embodiment.

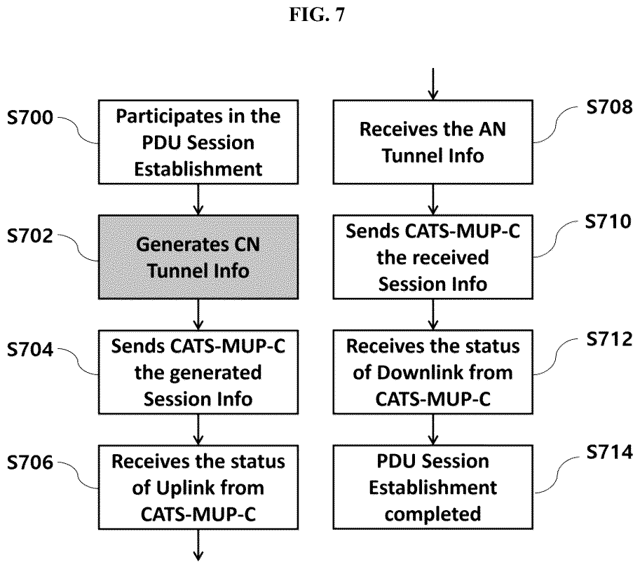

FIG. 7 is a flowchart showing a procedure in which the SMF according to the present embodiment independently completes PDU session establishment.

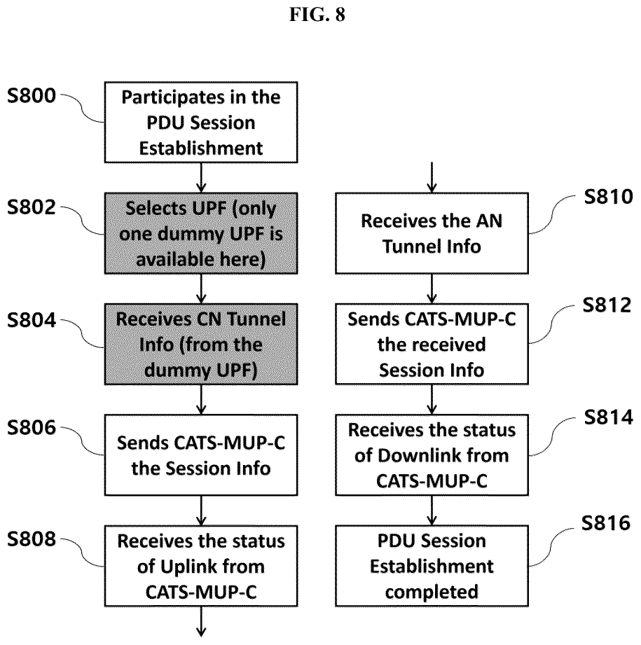

FIG. 8 is a flowchart showing a procedure for completing PDU session establishment using an anycast UPF according to the present embodiment.

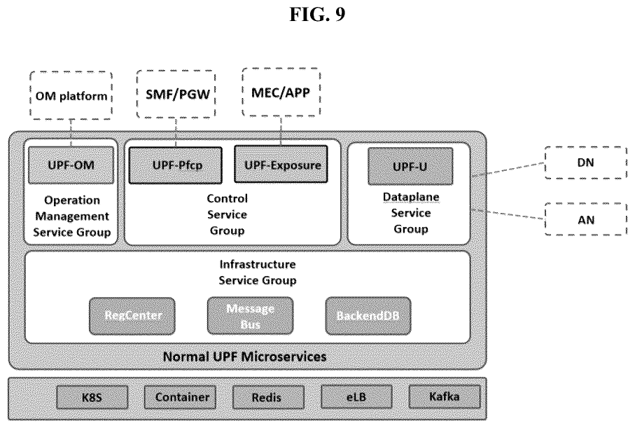

FIG. 9 is a diagram showing the configuration of a general UPF.

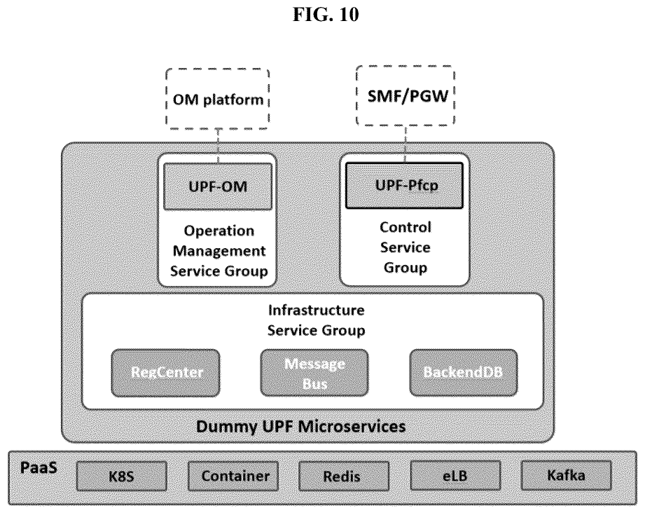

FIG. 10 is a diagram showing the configuration of an anycast UPF according to the present embodiment.

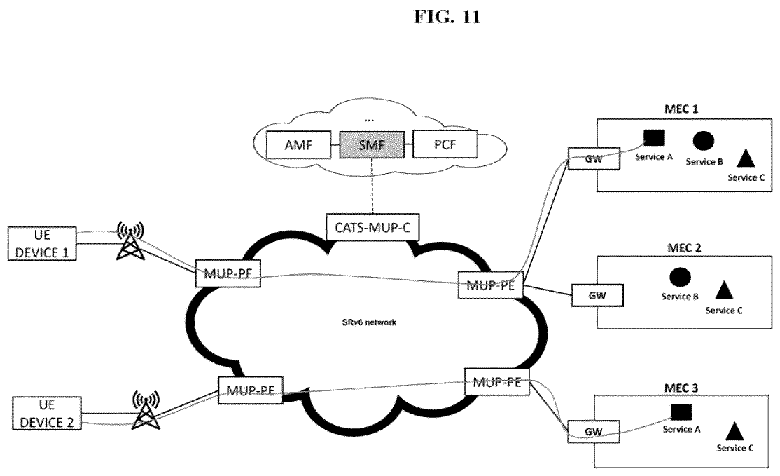

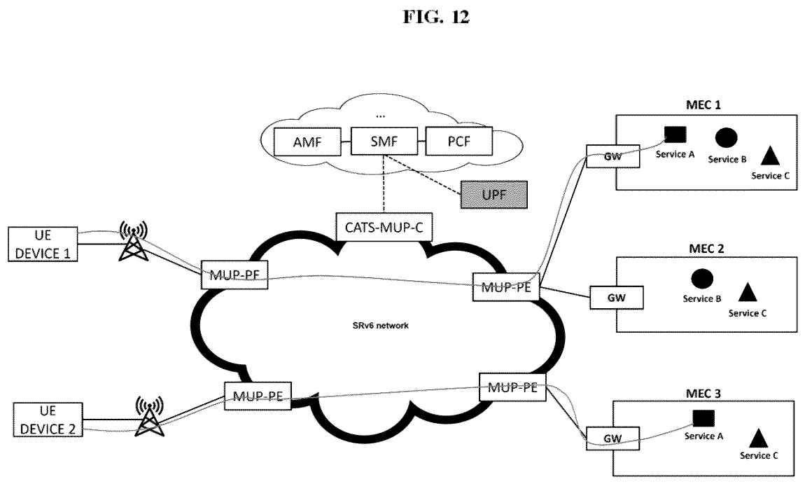

FIG. 11 to FIG. 12 are diagrams showing a packet transmission and reception process between UE and a data network (predetermined MEC) after the SMF according to the present embodiment completes PDU session establishment either independently or in cooperation with an anycast UPF.

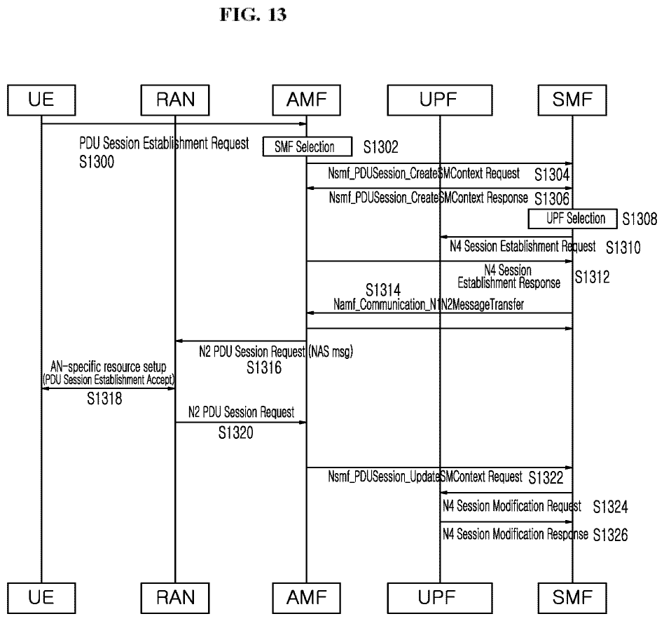

FIG. 13 is a diagram showing a process of establishing an anycast service PDU session using an SMF and a UPF according to the 3GPP TS 23.502 standard.

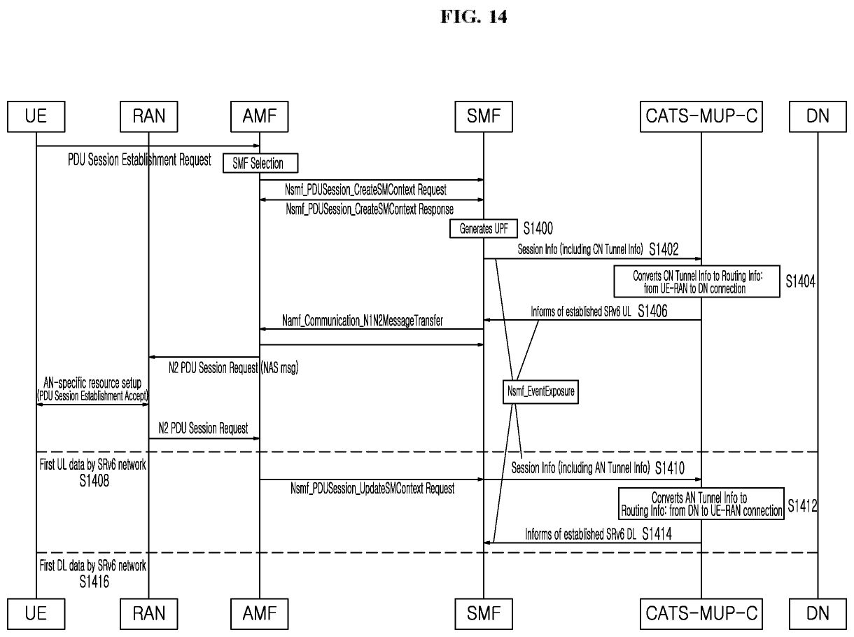

FIG. 14 is a diagram showing a procedure for establishing an anycast service PDU session using an SMF.

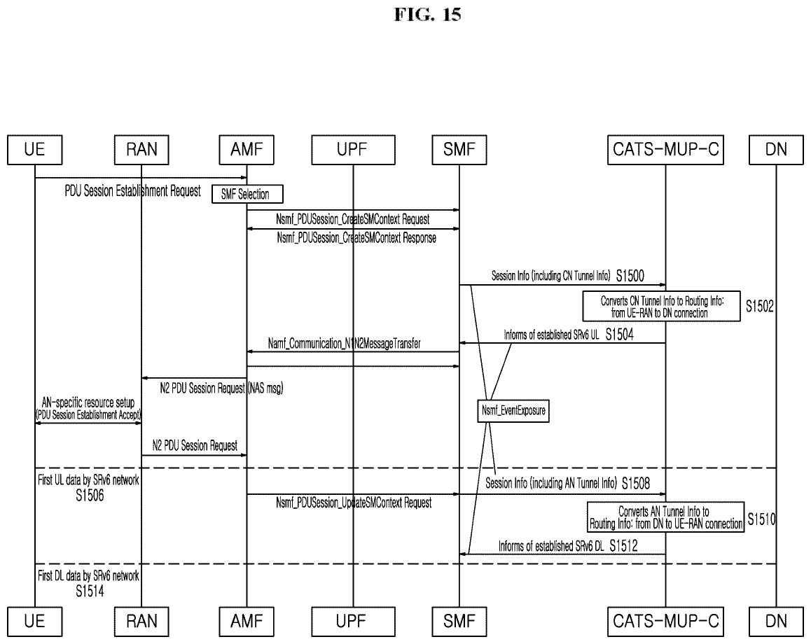

FIG. 15 is a diagram showing a procedure for establishing an anycast service PDU session using a UPF.

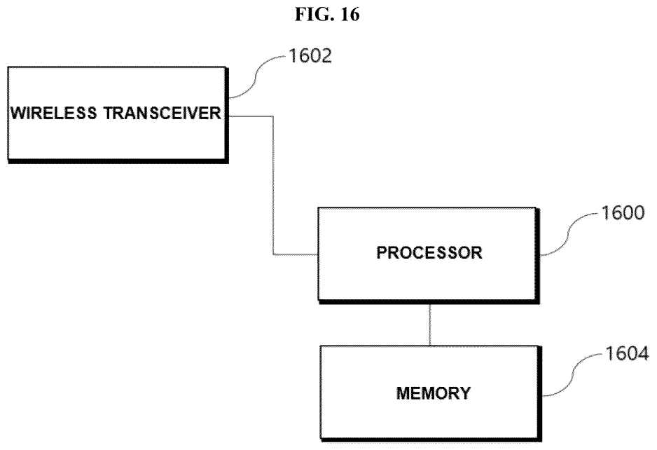

FIG. 16 is a diagram showing the detailed configuration of UE according to the present embodiment.

### DETAILED DESCRIPTION

The present disclosure may be modified in various ways and implemented by various exemplary embodiments, so that specific exemplary embodiments are shown in the drawings and will be described in detail herein. However, it is to be understood that the present disclosure is not limited to the specific exemplary embodiments, but includes all modifications, equivalents, and substitutions included in the spirit and the technical scope of the present disclosure.

The terms used in the present disclosure are used only in order to describe specific exemplary embodiments rather than limiting the present disclosure. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Further, the components of embodiments described with reference to the drawings are not limited only to corresponding embodiments and may be implemented to be included in other embodiments within the range of the spirit of the present disclosure, and it is also apparent that even though separate explanations are omitted, a plurality of embodiments may be integrated and re-implemented as a single embodiment.

Further, in description of the accompanying drawing, same components are given relevant or the same reference numerals regardless of the figure numbers and are not repeatedly described. In describing the present disclosure, detailed descriptions of well-known technologies will be omitted so as not to obscure the description of the present disclosure with unnecessary detail.

In the present embodiment, when there is an anycast IP-based service request from UE, a Session Management Function (SMF) of a mobile network establishes a PDU session for anycast services using a virtual User Plane Function (UPF) or a dummy UPF (hereinafter defined as anycast UPF) that only includes a control plane.

FIG. 4 is a diagram showing a system in which an SMF according to the present embodiment independently performs a PDU session establishment procedure, and FIG. 5 is a diagram showing a system in which the SMF according to the present embodiment performs a PDU session establishment procedure by communicating with an anycast UPF.

As shown in FIG. 4 to FIG. 5, an SMF according to the present embodiment requires modifications of the SMF to perform a PDU session procedure through a virtual UPF or an anycast UPF.

Although an actual PDU session is not created, a CATS-MUP-C according to the present embodiment collaborates with the SMF to create an SR underlay network connection from a UE-RAN to data network of an optimal anycast IP service instance or anycast IP service chaining instance.

FIG. 6 is a diagram showing an anycast service that is executed at an MEC site according to the present embodiment.

Referring to FIG. 6, in an anycast service, it is possible to provide high availability and reduce latency in user experience by executing the same service at multiple sites (MEC sites). Each MEC site has a gateway (GW) as the ‘front door’ to receive traffic coming into services. For example, a service A has two copies that are executed at MEC 1 and MEC 3. Accordingly, it is possible to provide optimal performance by processing traffic requests for the service A at the MEC 1 or the MEC 3 on the basis of the current state of available resources at each MEC site.

In the present embodiment, when UE connected to a mobile network makes an anycast IP-based service request, an SMF performs a PDU session establishment procedure for logical connection between the UE and a data network without selecting a UPF, and sends session information (Session Info) including Core Network (CN) Tunnel Info and AN (Access Network) Tunnel Info to a CATS-MUP-C via an Nsmf_EventExposure service to enable the setup of uplink and downlink between the UE and the data network.

Not selecting a UPF means that the SMF independently creates UPF parameters including the address of a virtual UPF and the Core Network side Tunnel Endpoint Identifier (TEID) for PDU session establishment, or transmits/receives N4 session establishment requests/responses with an anycast UPF that only includes a control plane, without transmitting and receiving packets.

The procedure for PDU session establishment, when a UE's PDU session establishment request includes an anycast IP address, means that instead of selecting a UPF with both control plane and data plane, the SMF independently creates CN Tunnel Info or receives CN Tunnel Info from the anycast UPF.

According to the present embodiment, the SMF sends session information including CN Tunnel Info to the CATS-MUP-C via the Nsmf_EventExposure service, and the CATS-MUP-C converts the session information into routing information for UE-RAN and the data network, thereby setting up uplink through a segment routing (SRv6) underlay network.

The Nsmf_EventExposure service according to the present embodiment includes UE's IP address/prefix, PDU session establishment and release-related information, user plane status information, and session information.

In the Nsmf_EventExposure service, an event ID “Session Info” is added as 3GPP TS 23.502 [4] described in the following Table 1.

As a result, the CATS-MUP-C can recognize the point at which a PDU session is requested and obtain the information necessary to prepare SRv6 MUP routing information. Further, the anycast IP address of a request service is also sent to the CATS-MUP-C to find an optimal service instance.

TABLE 1

| Event ID | Notification Information |
|---|---|
| UE IP address/Prefix | new UE IP address/Prefix or |
| allocation/change | an indication of which UE IP address/Prefix |
| | has been released. |
| PDU Session Establishment | PDU Session Type. |
| and/or PDU Session | DNN. |
| Release | UE IP address/Prefix. |
| User plane status | PDU Session ID. |
| information | User Plane Inactivity Timer. |
| | PDU Session status. |
| etc. | etc. |
| Session Info | AN Tunnel Info |
| | CN Tunnel Info |
| | UE IP address/Prefix |
| | Anycast IP address/Prefix |
| | etc. |

As described in Table 1, the session information according to the present embodiment may include, in addition to CN Tunnel Info, AN (Access Network) Tunnel Info, the IP address/prefix of the UE, and anycast IP address/prefix for connection to a data network.

When the SMF sends the AN Tunnel Info, the CATS-MUP-C converts the AN Tunnel Info into routing information and sets up a downlink by the segment routing underlay network.

FIG. 7 is a flowchart showing a procedure in which the SMF according to the present embodiment independently completes PDU session establishment.

Referring to FIG. 7, the SMF according to the present embodiment participates in a PDU session establishment when there is the PDU session establishment request for the UE's anycast-based service (Step 700).

Step 700 can be performed after transmitting and receiving session management context (CreateSMContext) request/response with an Access Management Function (AMF) receiving the PDU session establishment request.

The SMF creates CN Tunnel Info corresponding to the UPF parameters (Step 702) and sends session information including CN Tunnel Info to the CATS-MUP-C via the Nsmf_EventExposure service (Step 704).

Thereafter, it receives status information for uplink from the CATS-MUP-C(Step 706). In step 706, the CATS-MUP-C converts the CN Tunnel Info into a Direct Segment Discovery (DSD) route and advertises a type 2 Session-Transformed (ST) route to the MUP-PE to send the status information for uplink to the SMF.

Thereafter, the SMF receives AN Tunnel Info created at a gNB from the AMF (Step 708) and sends the session information including the AN Tunnel Info to the CATS-MUP-C (Step 710).

Thereafter, it receives status information for downlink from the CATS-MUP-C(Step 712).

The SMF completes PDU session establishment after checking the downlink setup status (Step 714).

FIG. 8 is a flowchart showing a procedure for completing PDU session establishment using an anycast UPF according to the present embodiment.

In FIG. 8, Step 800 is the same as Step 700, and Steps 804 to 814 are the same as Steps 702 to 714, respectively.

However, in Step 802, the SMF has only a single anycast UPF as the sole option.

As described above, the SMF receives CN Tunnel Info from the anycast UPF having only a control plane without a data plane, which performs packet transmission and reception, without selecting a UPF (Step 802).

FIG. 9 is a diagram showing the configuration of a general UPF, and FIG. 10 is a diagram showing the configuration of an anycast UPF according to the present embodiment.

Comparing FIG. 9 and FIG. 10, the anycast UPF according to the present embodiment includes only a Packet Forwarding Control Protocol (UPF-PFCP) component among the UPF-PFCP component and a UPF-EXPOSURE component included in a control service group and does not include a data plane service group for packet transmission and reception with an external network.

FIG. 11 to FIG. 12 are diagrams showing a packet transmission and reception process between UE and a data network (predetermined MEC) after the SMF according to the present embodiment completes PDU session establishment either independently or in cooperation with an anycast UPF.

Referring to FIG. 11 and FIG. 12, after the SMF completes the PDU session establishment independently or in cooperation with the anycast UPF, the CATS-MUP-C performs control such that packets are transmitted and received between the UE and the Mobile Edge Computing (MEC) selected for the anycast IP-based service through one or more MUP aware Provider Edge (MUP-PE) nodes.

Hereafter, a PDU session establishment procedure in the conventional 3GPP TS 23.502 standard of the related art and a PDU session establishment procedure according to the present embodiment are compared and described.

FIG. 13 is a diagram showing a process of establishing an anycast service PDU session using an SMF and a UPF according to the 3GPP TS 23.502 standard.

Referring to FIG. 13, UE requests PDU session establishment to an AMF (Step 1300). In order to establish a new PDU session, the UE creates a new PDU session ID. A PDU session establish request includes a PDU session ID, a requested PDU session type (request type), a requested Session and Service Continuity (SSC) mode, etc.

The requested PDU session type may be “early request” representing new PDU session establish or “existing PDU session” in which a request performs conversion between 3GPP access and non-3GPP access or represents PDU session handover from an existing Packet Data Network (PDN) connected to an Evolved Packet Core (EPC).

In the present embodiment, in consideration of only the case in which a request is ‘early request’, a PDU session establish request message may include a Session Management (SM) PDU DN request container including details for admitting a PDU session by an external DN.

An anycast service request by UE may include an anycast IP address.

The anycast IP address for a requested service may also be included in a PDU session establish request for the CATS-MUP-C that finds an optimal underlay routing route.

The AMF selects a corresponding SMF that can support an anycast service based on the requested anycast IP or a DNN (Step 1302).

The AMF identifies that the message is a request for a new PDU session with reference to the fact that a request type is designated as “early request” and a PDU session ID is not involved with the current PDU session.

When the AMF cannot select an SMF (e.g., when a DNN requested by UE is not supported in a network or is not on a subscription DNN list for Single-Network Slice Selection Assistance Information (S-NSSAI), the AMF performs one of two measures in accordance with an operator policy received from a Policy Control Function (PCF).

That is, the AMF rejects a Non Access Stratum (NAS) message including the UE's PDU session establishment request, or requests the PCF to replace the DNN requested by the UE with the selected DNN.

When the AMF cannot access SMF information through other methods such as local configuration in the AMF, it finds the SMF instance using a Network Repository Function (NRF).

The AMF shares UE location information with the NRF when attempting to search for an SMF instance. Thereafter, the NRF provides a Network Function (NF) profile of the SMF instance, along with an SMF service area of the SMF instance, to the AMF.

The SMF selection function in the AMF selects an SMF instance and an SMF service instance on the basis of the available SMF instances obtained from the NRF or the SMF information configured in the AMF.

There may be two ways for the AMF to select an SMF, in which one is to send only SMF information from the NRF to the AMF, or to indicate the local configuration of the AMF to an SMF.

The AMF can process a PDU session establishment request, create an SM context request (SMContext Request) and send it to the SMF (Step 1304), and receive an SM context ID from the SMF as a response (SMContext Response) (Step 1306).

When the SMF decides not to proceed with the PDU session establishment, it rejects the UE request via NAS SM signaling, including the appropriate SM rejection cause in the Nsmf_PDUSession_CreateSMContext response to the AMF.

Further, the SMF informs the AMF that the PDU session ID should be treated as released and stops the PDU session by the operator through an URSP rule update.

The SMF receives the list of allowed SSC modes and the default SSC mode for each S-NSSAI and DNN as part of the subscription information from Unified Data Management (UDM).

When the UE initiates a new PDU session request and specifies the SSC mode, the SMF accepts the requested mode or rejects the PDU session establishment request message, and determines the SSC mode and sends the allowed SSC mode back to the UE.

This determination takes into account factors such as PDU session type, subscription details, and/or local configuration.

Depending on the cause value and the allowed SSC mode, the UE can retry a PDU session establishment request using the allowed SSC mode or other UE Route Selection Policy (URSP) rules.

When the UE does not specify an SSC mode when requesting a new PDU session, the SMF selects a default SSC mode specified for subscription to the data network or applies local configuration to select it.

Thereafter, the SMF selects a UPF (Step 1308), and sends a N4 session establishment request to the selected UPF to provide packet detection to be installed in the UPF for the PDU session (Step 1310).

When the SMF is configured to request IP address allocation to the UPF, the SMF sends a signal to the UPF to perform IP address allocation, including all the information necessary for an IP address allocation process. Further, when trace requirements are received, the SMF forwards them to the UPF.

When the SMF activates a Reliable Data Service (RDS) for the PDU session, it shares RDS configuration information with the UPF at this stage. When a Small Data Rate Control parameter is required for the PDU session, the SMF provides it to the UPF. Finally, when Small Data Rate Control Status is received from the AMF, the SMF forwards it to the UPF.

The UPF responds to the SMF (Step 1312). In Step 1312, when the SMF instructs the UPF to execute IP address allocation, the response includes the requested IP address. Further, the requested CN Tunnel Info is forwarded to the SMF.

The SMF sends N1N2 information such as PDU session ID, a QoS Flow Identifier (QFI), and CN Tunnel Info to the AMF so that the AMF can send it to the RAN (Step 1314).

The N1 information includes PDU Session Accept for the UE.

N2 SM data includes details that the AMF needs to send to the RAN.

This includes the core network address of the N3 tunnel connected to the PDU session. The RAN can receive one or more QoS profiles along with the corresponding QFI. In addition, the PDU session ID can be used in AN signaling with the UE to notify the UE about the connection between the RAN resources for the UE and the PDU session.

The AMF sends the N1N2 information to the RAN (Step 1316).

The RAN can issue AN-specific signaling exchange related to the information received from the SMF with the UE and can forward the N1 information to the UE (Step 1318).

The RAN is also responsible for AN Tunnel Info allocation for the PDU session. The AN Tunnel Info consists of tunnel endpoints for all participating RAN nodes, along with the QFI allocated to each tunnel endpoint.

The RAN sends an N2 PDU session response including the PDU session ID, AN Tunnel Info, etc., to the AMF (Step 1320).

The AN Tunnel Info corresponds to the access network address of an N3 tunnel related to the PDU session.

The AMF sends N2 SM information to the SMF for continuation of the PDU session procedure (Step 1322).

In this case, the AMF uses Nsmf_PDUSession_UpdateSMContext. The request includes the task of sending an SM Context ID, N2 SM information, and a request type to the SMF, and then, the AMF relays the N2 SM information received from the RAN to the SMF.

The SMF provides the AN Tunnel Info to the UPF and the corresponding forwarding rule (Step 1324), and the UPF responds to the SMF (Step 1326).

FIG. 14 is a diagram showing a procedure for establishing an anycast service PDU session using an SMF, and FIG. 15 is a diagram showing a procedure for establishing an anycast service PDU session using a UPF.

In both cases of using the SMF or UPF shown in FIG. 14 and FIG. 15, the SMF is defined as a network function that sends session information to the CATS-MUP-C.

As a result, the CATS-MUP-C can be processed as a validated Application Function (AF) for a 5G core network and can connect to the SMF through a corresponding NF service, such as Nsmf_EventExposure, which provides PDU session-related events toward a consumer Network Function (NF).

Other NFs can subscribe to the activities of this service and receive notifications about what happens in the PDU session.

The Nsmf_EventExposure can be used for connection to the CATS-MUP-C. This service forwards PDU session-related events to the consumer NF. Through the exposed service operation, other NFs can subscribe to receive notifications about events occurring in the PDU session.

Since the SMF takes over the functions of the UPF in PDU session establishment in FIG. 14, Steps 1308 to 1312 and Steps 1324, and 1326 in FIG. 13 are replaced with new steps for uplink setup.

Referring to FIG. 14 again, after the SMF sends an SMContext response to the AMF (see Step 1306 in FIG. 13), instead of sending information to the UPF to set up rules for the PDU session, actual logical connection is created by the CATS-MUP-C, so UPF parameters are created (Step 1400).

As described above, in Step 1400, the SMF performs the PDU session establishment procedure for logical connection between the UE and the data network without selecting a UPF for packet transmission and reception.

In the SRv6 MUP network, since there is no need to use a UPF, the SMF can independently handle creation of CN Tunnel Info. Accordingly, the configuration of the UPF for creating CN Tunnel Info is moved to the SMF, and other functions of the SMF remain unchanged.

The SMF processes routing information of the SRv6 underlay network by sending session information including CN Tunnel Info to the CATS-MUP-C using the Nsmf_EventExposure service (Step 1402).

The CATS-MUP-C converts the session information into routing information (Step 1404).

The CATS-MUP-C advertises it to a corresponding MUP-PE.

Further, the CATS-MUP-C converts Direct Segment Discovery (DSD) and notifies the MUP-PE of the second type ST for the N6 interface. As a result, uplink is now set to the SRv6 MUP underlay network.

The CATS-MUP-C notifies the SMF to continue the procedure (Step 1406).

Through the process described above, the uplink by the segment routing underlay network is completely set up (Step 1408).

After the uplink setup is complete, the SMF forwards session information including the AN Tunnel Info to the CATS-MUP-C(Step 1410).

The CATS-MUP-C converts the session information into routing information of the SRv6 underlay network (Step 1412).

In Step 1412, the CATS-MUP-C receives the session information containing the AN Tunnel Info and then converts it into routing information. For the AN Tunnel Info, the path is set in the SRv6 MUP network using the ISD and the first type ST.

Next, the CATS-MUP-C notifies the SMF that the MUP network routing is completed (Step 1414).

Through the process described above, the downlink by the segment routing underlay network is completely set up (Step 1416).

The PDU session establishment is now completely replaced by the SRv6 CATS-MUP-C. Now, the requests from the UE are sent over the SRv6 MUP network, and for each request, the CATS-MUP-C determines an optimal service instance to serve the UE.

In the case of performing the procedure for establishing an anycast service PDU session using a UPF as shown in FIG. 15, the SMF, after the N4 session establishment request/response with the anycast UPF, forwards the session information including CN Tunnel Info to the CATS-MUP-C(Step 1500).

Steps 1500 to 1514 in FIG. 15 are the same as Steps 1402 to 1416 in FIG. 14, respectively, so detailed description of these steps is omitted.

FIG. 16 is a diagram showing the detailed configuration of UE according to the present embodiment.

As shown in FIG. 16, UE according to the present embodiment may include a processor 1600, a wireless transceiver 1602, and a memory 1604.

In this case, the processor 1600 may include a central processing unit (CPU) that can execute computer programs, or other virtual machines.

The memory 1604 may include a nonvolatile storage device such as a fixed-type hard drive or a detachable storage device. The detachable storage device may include a compact flash unit, a USB memory stick, etc. The memory 1604 may also include a volatile memory such as various random access memories, and may be defined as a computer-readable recording medium.

The wireless transceiver 1602 transmits/receives wireless signals through one or more antennas under the control by the processor 1600.

In the memory 1604 of the UE according to the present embodiment, program instructions for providing n anycast service are stored, and the processor 1600 executes the program instructions to transmit a PDU session establishment request signal for anycast-based services to a mobile network via the wireless transceiver 1602.

Further, the processor 1600 controls the wireless transceiver 1602 to perform a PDU session establishment procedure for logical connection with a data network without the selection of a User Plane Function (UPF) for packet transmission and reception via the SMF of the mobile network, and transmits session information including Core Network (CN) Tunnel Info to the Computing-Aware Traffic Steering-Mobile User Plane-Controller (CATS-MUP-C) via the Nsmf_EventExposure service such that packets are sent and received with the data network when uplink and downlink by a segment routing underlay network are set up.

The above embodiments of the present disclosure are disclosed for examples, various changes, modifications, and additions may be possible within the spirit and scope of the present disclosure by those skilled in the art, and those changes, modifications, and additions should be construed as being included in the following claims.

What is claimed is:

1. A dynamic anycast service-supported packet data unit (PDU) session establishment method for mobile networks, comprising steps of:
(a) transmitting/receiving a session management context (CreateSMContext) request/response with an Access Management Function (AMF) by means of a Session Management Function (SMF) when there is a PDU session establishment request for an anycast service of a user equipment (UE);
(b) performing a PDU session establishment procedure for logical connection between the UE and a data network without selecting a User Plane function (UPF) for packet transmission and reception by means of the SMF; and
(c) sending session information including Core Network (CN) Tunnel Info to a Computing-Aware Traffic Steering-Mobile User Plane-Controller (CATS-MUP-C) through a Nsmf_EventExposure service by means of the SMF,
wherein the CATS-MUP-C sets up uplink by a segment routing underlay network by converting the session information into routing information of a user equipment-radio access network (UE-RAN) and the data network.

2. The method of claim 1, wherein, in the step (b), the SMF independently creates UPF parameters including an address of a virtual UPF and a core network side tunnel endpoint identifier (TEID) for PDU session establishment.

3. The method of claim 1, wherein, in the step (b), the SMF transmits and receives N4 session establishment requests/responses with an anycast UPF that only includes a control plane, without transmitting and receiving packets.

4. The method of claim 3, wherein the anycast UPF includes only a Packet Forwarding Control Protocol (UPF-PFCP) component among the UPF-PFCP component and a UPF-EXPOSURE component included in a control service group, and does not include a data plane service group for packet transmission and reception with an external network.

5. The method of claim 1, wherein the Nsmf_EventExposure service includes IP address/prefix of the UE, PDU session establishment and release-related information, user plane status information, and session information.

6. The method of claim 5, wherein the session information includes the CN Tunnel Info, Access Network (AN) Tunnel Info, the IP address/prefix of the UE, and anycast IP address/prefix for connection to the data network.

7. The method of claim 6, further comprising sending the AN Tunnel Info to the CATS-MUP-C by means of the SMF,
wherein the CATS-MUP-C sets up downlink by the segment routing underlay network by converting the AN Tunnel Info into routing information.

8. The method of claim 7, wherein the CATS-MUP-C performs control such that packets are transmitted and received between the UE and Mobile Edge Computing (MEC) selected for the anycast service through one or more MUP aware Provider Edge (MUP-PE) nodes, after the PDU session establishment is completed through setup of the uplink and the downlink.

9. The method of claim 8, wherein the CATS-MUP-C converts the CN Tunnel Info into a Direct Segment Discovery (DSD) route and advertises a second type session-transformed (ST) route to the MUP-PE.

10. The method of claim 8, wherein the CATS-MUP-C converts the AN Tunnel Info into an Interwork Segment Discovery (ISD) route and sets up a route in the segment routing underlay network using a first type ST route.

11. A dynamic anycast service-supported packet data unit session establishment apparatus for mobile networks, comprising:
a processor; and
a memory connected to the processor,
wherein the memory stores program instructions that are executed by the processor
to transmit/receive a session management context (CreateSMContext) request/response with an Access Management Function (AMF) when there is a PDU session establishment request for an anycast service of a user equipment (UE);
to perform a PDU session establishment procedure for logical connection between the UE and a data network without selecting a User Plane Function (UPF) for packet transmission and reception; and
to send session information including Core Network (CN) Tunnel Info to a Computing-Aware Traffic Steering-Mobile User Plane-Controller (CATS-MUP-C) through a Nsmf_EventExposure service,
wherein the CATS-MUP-C sets up uplink by a segment routing underlay network by converting the session information into routing information of a user equipment-radio access network (UE-RAN) and the data network.

12. The apparatus of claim 11, wherein the apparatus comprises a Session Management Function (SMF), and
the SMF independently creates UPF parameters including an address of a virtual UPF and a core network side tunnel endpoint identifier (TEID) for PDU session establishment.

13. The apparatus of claim 11, wherein a Session Management Function (SMF) transmits and receives N4 session establishment requests/responses with an anycast UPF that only includes a control plane, without transmitting and receiving packets.

14. The apparatus of claim 13, wherein the anycast UPF includes only a Packet Forwarding Control Protocol (UPF-PFCP) component among the UPF-PFCP component and a UPF-EXPOSURE component for event exposure services included in a control service group, and does not include a data plane service group for packet transmission and reception with an external network.

15. The apparatus of claim 11, wherein the Nsmf_EventExposure service includes IP address/prefix of the UE, PDU session establishment and release-related information, user plane status information, and the session information.

16. A user equipment (UE) for providing an anycast service, comprising:
a wireless transceiver for transmitting and receiving wireless signals;
a memory storing program instructions; and
a processor executing the program instructions and controlling the wireless transceiver,
wherein the processor
connects to a mobile network through the wireless transceiver and transmits a PDU session establishment request signal for an anycast-based service to an Access Management Function (AMF); and
performs control to perform a PDU session establishment procedure for logical connection with a data network without selection of a User Plane Function (UPF) for packet transmission and reception via a Session Management Function (SMF) of the mobile network, and send session information including Core Network (CN) Tunnel Info to a Computing-Steering-Mobile User Plane-Controller (CATS-MUP-C) via a Aware Traffic Nsmf_EventExposure service such that packets are transmitted and received with the data network through the wireless transceiver when uplink and downlink by a segment routing underlay network are set up.
